(19) United States
(12) Patent Application Publication
(10) Pub. No.: US 2017/0157560 A1
(43) Pub. Date: Jun. 8, 2017

(54) INSTALLATION COMPRISING AN EXHAUST GAS-GENERATING TREATMENT DEVICE, AN OXIDATION CATALYTIC CONVERTER AND A REDUCTION CATALYTIC CONVERTER, AS WELL AS A METHOD FOR TREATING EXHAUST GAS IN SUCH AN INSTALLATION

(71) Applicants: ELEX CemCat AG, Schwerzenbach (CH); ThyssenKrupp Industrial Solutions AG, Essen (DE)

(72) Inventors: Franz Josef Zurhove, Waldshut-Tiengen (DE); Melanie Flasspöhler, Dortmund (DE); Timo Stender, Fröndenberg (DE); Kathrin Rohloff, Hamburg (DE)

(73) Assignees: ELEX CemCat AG, Schwerzenbach (CH); ThyssenKrupp Industrial Solutions AG, Essen (DE)

(21) Appl. No.: 15/316,620

(22) PCT Filed: Jun. 8, 2015
(86) PCT No.: PCT/EP2015/062729

§ 371 Date: Dec. 6, 2016

(30) Foreign Application Priority Data
Jun. 10, 2014 (DE) 10 2014 108 153.6

(51) Int. Cl. B01D 53/86; C04B 7/36

(52) U.S. Cl. CPC B01D 53/869; B01D 53/864; B01D 53/8625; C04B 7/364; B01D 2255/904

(57) ABSTRACT

A plant may include an offgas-producing treatment apparatus for mechanical and/or thermal treatment of an inorganic material, an oxidation catalyst downstream of the offgas-producing treatment apparatus in a flow direction of the offgas, a reduction catalyst downstream of the oxidation catalyst in the flow direction of the offgas, and a temperature-affecting apparatus for affecting the temperature of the offgas upstream of the oxidation catalyst and/or between the oxidation catalyst and the reduction catalyst. In some examples, the the temperature-affecting apparatus is controllable and may comprise at least one of an auxiliary preheater, a mixing-in device for a fluid, or a heat exchanger.

The invention relates to a plant having an offgas-producing treatment apparatus for mechanical and/or thermal treatment of an inorganic material, having an oxidation catalyst downstream of the treatment apparatus in flow direction of the offgas and having a reduction catalyst downstream of the oxidation catalyst in flow direction of the offgas. The invention further relates to a method of treating the offgas in such a plant.

A plant of the generic type is used, for example, in the production of cement clinker. This involves preheating the cement raw meal prior to introduction into a rotary kiln in a material preheater, generally in the form of a four- to six-stage cyclone preheater, by means of the offgas leaving the rotary kiln. This generally cools the offgas down to a temperature between 250° C. and 400° C.

Further devices may be integrated over the course of the offgas line, which are preferably operated at higher than these customary offgas temperatures (downstream of material preheater). More particularly, an apparatus for offgas treatment by means of catalytic and/or (regenerative) oxidative lowering of pollutant levels may be provided.

For the offgas treatment apparatus, the setting of an appropriate offgas temperature may be required in order to be within an appropriate temperature range for (high) lowering of pollutant levels. Such a setting of the offgas temperature upstream of the offgas treatment apparatus can be effected by means of various measures, for example an introduction of water, a heat exchanger with heat supply or removal or an addition of another gas stream at a different temperature. If, for example, the offgas temperature is to be increased downstream of the material preheater, this can be achieved by means of additional supply of heat, for example by means of an auxiliary heater, for example in the form of burners or a combustion chamber.

DE 197 20 205 A1 discloses a method of cleaning offgas laden with nitrogen oxides, in which the offgas is preheated in a heat exchanger, then reheated by means of a burner and subsequently supplied to a reduction catalyst with addition of a reducing agent. The hot offgases leaving the reduction catalyst are utilized to charge one of two heat storage means. During this time, the other heat storage means serves as heat exchanger for the offgas to be supplied to the reduction catalyst. As a result of cyclical switching of the two heat storage means, one of the heat storage means is thus always being charged, while the other heat storage means is being utilized as heat exchanger for preheating the offgas.

DE 197 20 205 A1 further discloses the possibility of a combination of the reduction catalyst with an oxidation catalyst downstream thereof, by means of which organic compounds and especially furans and dioxins are to be removed simultaneously from the offgas.

In addition, DE 10 2010 060 104 B4 has disclosed an apparatus for treatment of offgases from, for example, a plant for cement clinker production. The apparatus comprises a multilayer catalyst having at least three catalyst layers arranged in succession with at least partly different lengths. Optionally, it may be the case that the first of the layers takes the form of an oxidation catalyst, while a feed unit for an ammonia-containing reducing agent follows on only after this first catalyst layer.

Proceeding from this prior art, it was an object of the invention to specify an advantageous means of offgas treatment of offgas originating from a treatment apparatus for mechanical and/or thermal treatment of an inorganic material and especially of offgas originating from a cement clinker kiln.

This object is achieved by means of a plant as claimed in claim 1 and a method as claimed in claim 9. Advantageous configurations of the plant of the invention and advantageous embodiments of the method of the invention are the subject matter of the further claims and will be apparent from the description of the invention which follows.

The invention is based on the finding that, in a reversal of the sequence of reduction catalyst and oxidation catalyst compared to the apparatus for offgas treatment known from DE 197 20 205 A1, it is possible to achieve relevant advantages which can more than compensate for the disadvantages associated with the reversal.

A further basic idea of the invention is that the two catalyst types should be supplied with the offgas with a temperature optimally adjusted as far as possible, in order to achieve high degrees of lowering of the respective pollutant levels. In this context, it can be assumed in principle that the degrees of lowering for carbon monoxide and/or organic hydrocarbons in an oxidation catalyst and for organic hydrocarbons in a reduction catalyst rise with rising offgas temperature. For lowering of carbon monoxide in an oxidation catalyst, a minimum temperature of 180° C. is stated, for example, in VDI Guideline 3476. If a relevant lowering of organic hydrocarbons is also envisaged, this generally requires higher offgas temperatures of, for example, at least 360° C. If sufficient lowering of methane is to be achieved by means of the oxidation catalyst, the offgas temperature in the oxidation catalyst should be at least 400° C. A further advantage of higher offgas temperatures in an oxidation catalyst lies in the distinctly slowed deactivation of the oxidation catalyst. Such high offgas temperatures can lead to rapid deactivation in the case of a reduction catalyst, for example an SCR catalyst. In a mode of connection corresponding to DE 10 2010 060 104 B4, this problem would be aggravated by the exothermic oxidation of the pollutants in the oxidation catalyst, which could lead to a further increase in the temperature of the offgas leaving the oxidation catalyst. In order to slow deactivation of the reduction catalyst, therefore, the temperature of the offgas entering the reduction catalyst should be limited.

A plant of the invention with an offgas-producing treatment apparatus for mechanical and/or thermal treatment of an inorganic material, having a preferably noble metal-containing oxidation catalyst downstream of the treatment apparatus in flow direction of the offgas and having a reduction catalyst downstream of the oxidation catalyst in flow direction of the offgas, is consequently characterized by an apparatus for affecting the temperature of the offgas arranged upstream of the oxidation catalyst (i.e. upstream of the oxidation catalyst in flow direction of the offgas) and/or a temperature-affecting apparatus for affecting the temperature of the offgas arranged downstream of the oxidation catalyst (i.e. beyond the oxidation catalyst in flow direction of the offgas) and upstream of the reduction catalyst.

In this case, the temperature-affecting apparatus arranged upstream of the oxidation catalyst preferably brings about heating of the offgas. The temperature-affecting apparatus arranged between the oxidation catalyst and the reduction catalyst preferably brings about cooling of the offgas.

Especially when one temperature-affecting apparatus is arranged upstream of the oxidation catalyst and one between the oxidation catalyst and reduction catalyst, the process of the invention enables very substantially optimal setting of the temperatures of the offgas entering each of the catalysts.

A process of the invention, especially one performable by means of a plant of the invention, for treating the offgas from a treatment apparatus for mechanical and/or thermal treatment of an inorganic material is characterized in that the offgas is supplied with a temperature of at least 360° C., 390° C., 400° C., 420° C. or 440° C. to an oxidation catalyst for oxidation of carbon monoxide (CO) and/or organic hydrocarbons (CₓH_{y}), preferably also methane, and then is supplied to a reduction catalyst for reduction of nitrogen oxides (NOₓ). In this case, the offgas should be supplied to the reduction catalyst advantageously at a maximum of 420° C., preferably 400° C. and more preferably 380° C. At the same time, the temperature of the offgas supplied to the reduction catalyst should advantageously not be below 150° C., preferably 180° C. and more preferably 220° C.

The oxidation catalyst and/or the reduction catalyst may have one or more layers. Two or more identical catalysts/catalyst layers may also be connected in parallel in the offgas line of the plant.

The temperature-affecting apparatus(es) may be configured as desired.

If the temperature-affecting apparatus(es) are to achieve an increase in the offgas temperature, this may especially be based on auxiliary firing (i.e. the combustion of a fuel with the primary or exclusive aim of introducing heat into the offgas), mixing-in of a fluid, especially a gas, having a higher temperature compared to the local temperature of the offgas, and/or heat exchange with any heat exchanger medium. The temperature-affecting apparatus for this purpose may be an auxiliary heater, a mixing-in device for a fluid, especially a gas (for example another offgas or a cooling gas from the plant), and/or a heat exchanger.

If the temperature-affecting apparatus(es) are to achieve a lowering of the offgas temperature, this may especially be based on mixing-in of a gas having a lower temperature compared to the local temperature of the offgas, mixing-in of a medium that evaporates at the relevant temperatures, preferably water or an aqueous solution, and/or heat exchange with any heat exchange medium. The temperature-affecting apparatus for this purpose may be a mixing-in device for a fluid, especially a gas or water or an aqueous solution, and/or a heat exchanger.

The temperature-affecting apparatus(es) is/are preferably designed so as to be controllable with regard to the affecting of the offgas temperature and more preferably under closed-loop control, such that very exact setting of the temperature of the offgas adjustable to changing circumstances (especially temperature and composition of the offgas on entry into the temperature-affecting apparatus) for the entry into the oxidation and/or reduction catalyst that follows downstream of the temperature-affecting apparatus is possible.

If one temperature-affecting apparatus is provided upstream of the oxidation catalyst and one between the oxidation catalyst and reduction catalyst, in a preferred embodiment of such a plant of the invention, it may also be the case that, by means of a common heat exchanger or by means of one heat exchanger for each of the temperature-affecting apparatuses using one transfer medium, heat is transferred from offgas downstream of the oxidation catalyst to offgas upstream of the oxidation catalyst.

In a preferred embodiment of the method of the invention, it may be the case that there is closed-loop control of the temperature of the offgas supplied to the oxidation catalyst by adjusted heat exchange of the offgas with the material to be supplied to the treatment apparatus. For this purpose, the temperature-affecting apparatus arranged upstream of the oxidation catalyst in the plant of the invention may comprise a material preheater arranged between the treatment apparatus and the oxidation catalyst, in which heat is transferred from the offgas to the material. Adjustment of the temperature of the offgas entering the oxidation catalyst can then be achieved by virtue of the heat exchange of the offgas with the material to be preheated being adjustable and especially controllable by closed-loop control.

For this purpose, the material preheater may comprise one or more heat exchanger stages, wherein a first feed for the material is arranged upstream of a heat exchanger stage in the direction of flow of the material through the material preheater, a second feed for the material, based on the direction of flow of the material through the material preheater, is arranged beyond this heat exchanger stage, and a control unit for adjusted division of the material between the first feed and the second feed is provided. In this case, the control unit may preferably be designed as a closed-loop control unit, in which case it utilizes, as controlled variable, for example, the offgas temperature to be set or an offgas composition upstream and/or downstream of the oxidation catalyst (and optionally also of the reduction catalyst).

For the reduction catalyst, a metering apparatus for an especially an ammonia-containing reducing agent (especially in liquid or gaseous form) is preferably provided. The metering apparatus may advantageously be arranged here between the oxidation catalyst and the reduction catalyst, by means of which contacting of the oxidation catalyst with the reducing agent can be avoided. The metering apparatus may advantageously also function as a temperature-affecting apparatus, in that the reducing agent metered in withdraws heat energy from the offgas as a result of evaporation. For this purpose, it is especially possible to provide for metered addition of an aqueous ammonia solution.

In a further-preferred configuration of the plant of the invention, a unit for dedusting may additionally be provided for the oxidation catalyst and/or the reduction catalyst, by means of which settling of dust on elements of the catalyst unit can be prevented and/or already settled dust can be removed again. This unit for dedusting may take the form, for example, of a dust blower known per se, especially a dust blower designed for use in cement processing plants.

The integration of one or more units for dedusting in the plant of the invention may especially be advisable because of the amounts of dust present in the offgas when a dust filter follows on from the catalysts in flow direction of the offgas and, consequently, the offgas is not dedusted until downstream of the reduction catalyst. This is because, in the case of such a high-dust arrangement of the catalysts, the dust content in the offgas up to the dust filter, at least when cement clinker is being fired by means of the treatment apparatus, may be up to 100 g/m³ (STP) or even higher.

However, a dust filter which is advantageous in principle may also be integrated elsewhere and especially upstream of the oxidation catalyst in the offgas line of the plant of the invention.

The plant of the invention is especially suitable for the production and/or processing of material(s) in the primary industry, especially of raw materials in the coal and steel industry, and specifically of cement clinker, lime and minerals.

The plant of the invention may also comprise further plants or plant components that do not serve for treatment of an inorganic material. More particularly, for a temperature-affecting apparatus in the form of a mixing-in device or a heat exchanger, it is possible to utilize a component and especially a material or fluid stream included in the component from a plant or apparatus for a different use, for example in the power plant industry (especially combustion of materials (especially raw materials, but also, for example, waste) for generation of electrical energy). These plants or apparatuses for a different use may, for example, serve for drying, torrefaction and/or pyrolysis of a carbonaceous material or fluid stream in particular.

The affecting of the temperature of the offgas upstream of the oxidation catalyst and/or the reduction catalyst need not be directed to the achievement of a maximum degree of lowering. Instead, lowering may also be envisaged to such a degree that legal emissions regulations are satisfied. In this case, a smaller degree of lowering than the maximum possible may be accepted in order, for example, to limit the thermal stress for the plant components and especially the catalysts and/or additional conversion of fuel, for example in one or more temperature-affecting apparatuses designed as auxiliary heaters.

The use of indefinite articles (“a”), especially in the claims and the part of the description that elucidates them, should be understood as such and not construed to mean “one”. Such a use should thus be understood such that at least one of the elements identified thereby is present and more than one may be present.

The invention is elucidated in detail hereinafter with reference to working examples illustrated in the drawings. The drawings show:

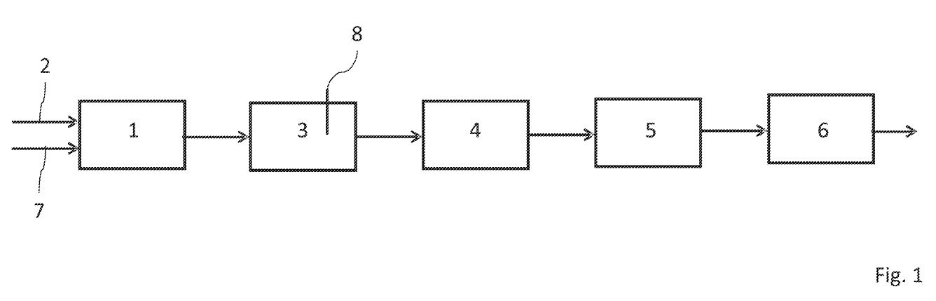

FIG. 1: a plant of the invention in a schematic view;

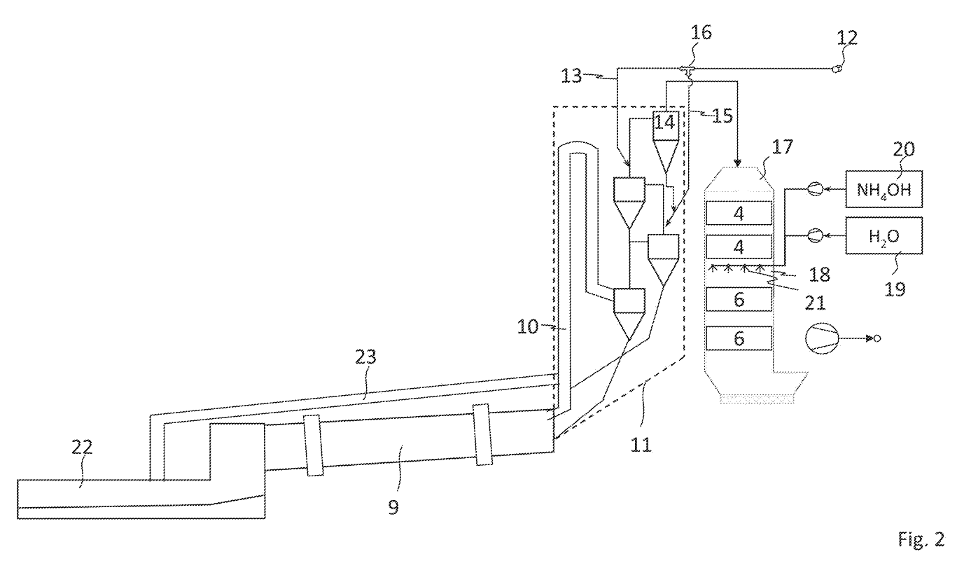

FIG. 2: a plant of the invention for production of cement clinker in a schematic view.

FIG. 1 shows, in highly simplified form, a plant of the invention with a treatment apparatus 1 for mechanical and/or thermal treatment of an inorganic material 2 and with an offgas line downstream of the treatment apparatus 1, in which offgas that has left the treatment apparatus 1 is cleaned; in other words, the concentrations of particular pollutants in the offgas are lowered.

The offgas line comprises—in flow direction of the offgas—a first temperature-affecting apparatus 3, an oxidation catalyst 4, a second temperature-affecting apparatus 5 and a reduction catalyst 6.

The treatment apparatus 1 is supplied with the material 2 to be treated and a fuel 7. The material 2 is treated thermally by combustion of the fuel 7 in the treatment apparatus 1. The offgas formed is heated further to a temperature of, for example, about 440° C. in the first temperature-affecting apparatus 3. This enables high degrees of lowering for the concentrations of both carbon monoxide and organic hydrocarbons in the oxidation catalyst 4 which follows downstream of the first temperature-affecting apparatus 3.

To increase the offgas temperature, the first temperature-affecting apparatus 3 may comprise, for example, a heat exchanger, by means of which heat is transferred from any other fluid, for example the offgas downstream of the oxidation catalyst 4 and upstream of the reduction catalyst 6 to the offgas. In addition, the first temperature-affecting apparatus 3 may also comprise an auxiliary heater 8, by means of which further heating of the offgas is possible in addition to that by the heat exchanger. Such an auxiliary heater 8 is advisably usable especially when heat transfer in the heat exchanger is insufficient to reliably heat the offgas to the desired target temperature. An additional factor is that the introduction of heat into the offgas by means of an auxiliary heater 8 can be controlled efficiently by closed-loop control via the fuel conversion.

The temperature of the offgas leaving the oxidation catalyst 4 is too high for the downstream reduction catalyst 6. Therefore, provision is made for cooling of the offgas in the second temperature-affecting apparatus 5 to not more than about 380° C. This can be effected, for example—in addition to any cooling resulting from heat exchange with the offgas upstream of the oxidation catalyst 4—through the injection of an aqueous ammonia solution, in which case the heat energy required for the evaporation of the solution is withdrawn from the offgas. The ammonia in the solution still serves as reducing agent for the lowering of the concentrations of nitrogen oxides in the offgas effected in the reduction catalyst 6.

FIG. 2 shows a plant corresponding essentially to the plant according to FIG. 1 in a more specific configuration. This plant serves for production of cement clinker which is fired in a treatment apparatus in the form of a rotary kiln 9 from cement raw meal. For this purpose, the finely ground cement raw meal comprising organic constituents is dispersed in hot combustion gases which originate from the rotary kiln 9 and an optionally present calciner 10, the organic constituents being driven out of the cement raw meal and incompletely combusted.

Upstream of the rotary kiln 9 is, based on the flow direction of the material (2) (cement raw meal or cement clinker), a material preheater 11 in the form of a multistage cyclone preheater with integrated calciner 10. In the material preheater 11, the offgas originating from the rotary kiln 9 flows through the cement raw meal in several stages and entrains it, and it is then separated again from the offgas stream in a cyclone of the respective preheater stage. The cyclone preheater, as usual, has a vertical construction, such that the cement raw meal, to the extent that it is entrained by the offgas stream, moves primarily counter to the direction of gravity and, after the separation in the cyclones, falls under gravity to the next preheater stage in each case. Other standard types of material preheaters, for example staged dwell reactors, are likewise possible.

The cement raw meal is fed to the plant via a cement raw meal feed 12 and supplied to the material preheater 11. The material preheater 11 serves simultaneously as the first temperature-affecting apparatus 3 of the plant of the invention. For this purpose, the cement raw meal is divided between a first feed 13 which, based on the direction in which the cement raw meal passes through the material preheater 11, is arranged upstream of the first (here the uppermost) heat exchanger stage 14, and a second feed 15. The cement raw meal introduced into the material preheater 2 via this first feed 4 thus takes part in heat exchange with the offgas in this first heat exchanger stage 14 (and also all other heat exchanger stages). The second feed 15 for the cement raw meal is, based on the direction of passage of the cement raw meal through the material preheater 11, arranged beyond the first heat exchanger stage 14. The cement raw meal introduced into the material preheater 11 via this second feed 15 thus does not take part in heat exchange with the offgas in the first heat exchanger stage 14, but does so in all other heat exchanger stages. When a portion of the cement raw meal does not pass through all heat exchanger stages, the total heat transfer of the offgas to the material to be preheated remains below a plant-specific and operating parameter-dependent maximum, which affects both the temperature of the preheated cement raw meal and the temperature of the offgas leaving the material preheater 11.

The parameters of the cement raw meal streams introduced into the material preheater 11 via the first feed 13 and the second feed 15 can be adjusted via a control unit 16. This consequently enables adjusted setting of the temperature of the offgas leaving the material preheater 11, which is then supplied to an offgas treatment apparatus 17. Specifically, this control unit 16 is designed as a closed-loop control unit which controls the parameters of the cement raw meal streams introduced into the material preheater 11 via the first feed 13 and the second feed 15 as a function of a measured temperature of the offgas entering the offgas treatment apparatus 17, such that the offgas temperature measured is within a target temperature range. This target temperature range is chosen with regard to a maximum degree of reduction of pollutant levels by means of a multilayer oxidation catalyst 4 in the offgas treatment apparatus 17 and is, for example, between about 360° C. and about 440° C., depending on the specific offgas composition.

Downstream of the oxidation catalyst 4 in flow direction of the offgas is a multilayer reduction catalyst 6. This is based on the principle of the selective catalytic reduction of nitrogen oxides in particular. For this purpose, a reducing agent in the form of ammonium hydroxide is added to the offgas in a known manner upstream of the reduction catalyst 6 (and downstream of the oxidation catalyst 4), which especially features a shorter evaporation distance compared to (the likewise possible use of) urea as reducing agent. Moreover, urea would release carbon monoxide in the breakdown, which is to be avoided. In the reduction catalyst 6, the nitrogen oxides are reduced with the ammonia to nitrogen and water and organic hydrocarbons still present in the offgas are lowered further.

The oxidation catalyst 4 and the reduction catalyst 6 are integrated in the same housing 18 of the offgas treatment apparatus 17.

The temperature of the offgas leaving the oxidation catalyst 4 is too high for lasting contact with the reduction catalyst 6. More particularly, such high temperatures of the offgas entering the reduction catalyst 6 would lead to the relatively rapid deactivation thereof. The plant therefore has, as the second temperature-affecting apparatus 5, a cooling apparatus for the offgas to be introduced into the reduction catalyst 6. This cooling apparatus takes the form of a metering apparatus 19 for water, which has an integral design together with a metering apparatus 20 for the ammonium hydroxide. A mixture of ammonium hydroxide and water is thus introduced into the offgas stream via a common nozzle apparatus 21. The water introduced evaporates in the offgas stream and withdraws heat energy therefrom as a result, which leads to lowering of the temperature of the entire offgas stream which then also comprises the evaporated water and ammonium hydroxide.

As a result, the temperature of the offgas entering the reduction catalyst 6 is limited to preferably not more than 380° C. In order to be able to achieve good closed-loop control of the mixing of ammonium hydroxide and water, the integral metering apparatus does not have any return line.

The adjusted heat exchange, which has especially been reduced compared to the maximum heat exchange performance of the material preheater 11, from the offgas to the cement raw meal to be preheated does not just affect the temperature of the offgas entering the offgas treatment apparatus 17 but also affects the temperature of the cement raw meal entering the rotary kiln 9. More particularly, this temperature of the preheated cement raw meal may be relatively low, but this can be compensated for by elevated fuel conversion in one or more burners (not shown) in the rotary kiln 9 which serve as heat-generating apparatuses or—if present—the calciner 10. At the same time, the fuel conversion and hence the introduction of heat into the rotary kiln 9 and into the offgas can be adjusted by means of an open-loop control unit or controlled by means of a closed-loop control unit. In this case, the temperature of the offgas entering the offgas treatment apparatus 17 may be a controlled variable for the fuel conversion. Alternatively or additionally, other parameters may also serve as controlled variable, for example a gas temperature in the calciner 10 optionally present in the plant.

In the calciner 10, the cement raw meal already preheated in the cyclone preheater can be precalcined, and it is then finally calcined to cement clinker in the rotary kiln 9. Heating and deacidification of the cement raw meal in the precalcination in the calciner 10 is accomplished by utilizing offgas withdrawn from the rotary kiln 9 (and heated cooling air from a clinker cooler 22 downstream of the rotary kiln 9 (based on the flow direction of the cement clinker), which is supplied to the calciner 10 via a tertiary air conduit 23). In this case, the material precalcined in the calciner 10 is separated from the offgas and/or the cooling air in the cyclone of the last heat exchanger stage of the material preheater 11.

### LIST OF REFERENCE NUMERALS

1. treatment apparatus
2. material
3. first temperature-affecting apparatus
4. oxidation catalyst
5. second temperature-affecting apparatus
6. reduction catalyst
7. fuel
8. auxiliary heater
9. rotary kiln
10. calciner
11. material preheater
12. cement raw meal feed
13. first feed
14. first heat exchanger stage
15. second feed
16. control unit
17. offgas treatment apparatus
18. housing
19. metering apparatus for water
20. metering apparatus for ammonium hydroxide
21. nozzle apparatus
22. clinker cooler
23. tertiary air conduit

1.-14. (canceled)

15. A plant comprising:
an offgas-producing treatment apparatus for at least one of mechanical or thermal treatment of an inorganic material;
an oxidation catalyst downstream of the offgas-producing treatment apparatus in a flow direction of the offgas;
a reduction catalyst downstream of the oxidation catalyst in the flow direction of the offgas; and
a temperature-affecting apparatus for affecting a temperature of the offgas, wherein the temperature-affecting apparatus is positioned upstream of the oxidation catalyst or between the oxidation catalyst and the reduction catalyst.

16. The plant of claim 15 wherein the temperature-affecting apparatus comprises at least one of an auxiliary preheater, a mixing-in device for a fluid, or a heat exchanger.

17. The plant of claim 15 wherein the temperature-affecting apparatus is controllable with regard to affecting the temperature of the offgas.

18. The plant of claim 15 further comprising a material preheater that is positioned between the offgas-producing treatment apparatus and the oxidation catalyst, wherein heat is transferred from the offgas to the inorganic material in the material preheater.

19. The plant of claim 18 wherein the material preheater comprises one or more heat exchanger stages, wherein a first feed for the inorganic material is positioned beyond a heat exchanger stage in a direction of flow of the inorganic material through the material preheater, wherein based on the direction of flow of the inorganic material through the material preheater a second feed for the inorganic material is positioned upstream of the heat exchanger stage, with the material preheater comprising a control unit for dividing the inorganic material between the first and second feeds.

20. The plant of claim 15 further comprising a metering apparatus for a reducing agent positioned between the oxidation and reduction catalysts.

21. The plant of claim 15 further comprising a dust filter positioned downstream of the reduction catalyst.

22. The plant of claim 15 further comprising a unit for freeing at least one of the oxidation catalyst or the reduction catalyst of dust.

23. A method of treating an offgas from a treatment apparatus for at least one of mechanical or thermal treatment of an inorganic material, the method comprising:
supplying the offgas to an oxidation catalyst for oxidation of at least one of carbon monoxide or organic hydrocarbons at a temperature of at least 360° C.; and
supplying the offgas to a reduction catalyst for reduction of nitrogen oxides.

24. The method of claim 23 wherein the offgas is supplied to the reduction catalyst at a temperature of not more than 420° C.

25. The method of claim 24 wherein the offgas that is supplied to the reduction catalyst at the temperature of not more than 420° C. is brought to the temperature of not more than 420° C. by way of at least one of auxiliary firing, mixing-in of a fluid, or heat exchange with a heat exchanger medium.

26. The method of claim 24 wherein closed-loop control of the temperature of the offgas to be supplied to the reduction catalyst is effected by metered addition of water to the offgas.

27. The method of claim 23 wherein the offgas is supplied to the reduction catalyst at a temperature of not more than 420° C.

28. The method of claim 23 wherein the offgas is supplied to the reduction catalyst at a temperature of not more than 380° C.

29. The method of claim 23 wherein the offgas is supplied to the reduction catalyst at a temperature of not more than 320° C.

30. The method of claim 23 further comprising dedusting the offgas downstream of the reduction catalyst.

31. The method of claim 23 wherein the offgas that is supplied to the oxidation catalyst at the temperature of at least 360° C. is brought to the temperature of at least 360° C. by way of at least one of auxiliary firing, mixing-in of a fluid, or heat exchange with a heat exchanger medium.

32. The method of claim 23 wherein the offgas that is supplied to the oxidation catalyst at the temperature of at least 360° C. is brought to the temperature of at least 360° C. by way of adjusted heat exchange of the offgas with the inorganic material to be supplied to the treatment apparatus.

33. The method of claim 23 wherein the offgas is supplied to the oxidation catalyst at a temperature of at least 400° C.

34. The method of claim 23 wherein the offgas is supplied to the oxidation catalyst at a temperature of at least 440° C.
